(19) United States
(12) Patent Application Publication
(10) Pub. No.: US 2015/0088059 A1
(43) Pub. Date: Mar. 26, 2015

(54) PILL ADMINISTRATION DEVICE WITH LIQUID RESERVOIR

(71) Applicant: Ino-Products Inc., Toronto (CA)

(72) Inventor: Douglas Bruce Soper, Toronto (CA)

(73) Assignee: lno-Products Inc., Toronto (CA)

(21) Appl. No.: 14/491,476

(22) Filed: Sep. 19, 2014

Related U.S. Application Data
(60) Provisional application No. 61/880,614, filed on Sep. 20, 2013.

(51) Int. Cl. A61J 7/00; A61J 1/20

(52) U.S. Cl. CPC A61J 7/0046; A61J 1/2093
USPC 604/78

(57) ABSTRACT

This disclosure describes liquid-assisted pill administration devices, each comprising a reservoir for containing a liquid and a pill receptacle for one or more pills. The pill receptacle has a receptacle opening remote from the reservoir for inserting and discharging pills, and the reservoir is in valve-governed fluid communication with the pill receptacle via a first fluid communication path including a valve interposed between the reservoir and the pill receptacle. In some embodiments, when the reservoir contains liquid and is above the pill receptacle and the valve is open, liquid in the reservoir flows under gravity from the reservoir to the pill receptacle via the first fluid communication path and air flows into the reservoir via a second fluid communication path. In other embodiments, the reservoir is collapsible and when the valve is in an open configuration, collapsing the reservoir forces liquid contained therein through the valve into the pill receptacle.

### CROSS-REFERENCE TO RELATED APPLICATION

This application claims the benefit of U.S. Provisional Application No. 61/880,614, filed on Sep. 20, 2013, the entirety of which is incorporated herein by reference.

The subject matter of this application is related to co-pending U.S. application Ser. No. 13/932,223 filed on Jul. 1, 2013, and co-pending U.S. design patent application Ser. No. 29/467,652 filed on Sep. 20, 2013, the teachings of which are incorporated herein by reference in their entireties.

### TECHNICAL FIELD

The present disclosure relates to pill administration devices, and more particularly to pill administration devices for using liquids to administer pills.

### BACKGROUND

Medication, vitamins, nutritional supplements and other materials are often administered in pill form. The term “pill”, as used herein, includes not only agglomerations of particulate matter (whether coated or uncoated), but also liquid-filled and powder-filled capsules having at least a solid exterior and administered by swallowing, including prescribed medication, over-the-counter medication, and vitamins and other nutritional supplements.

Many people find it easier to swallow pills when swallowing liquid at the same time. To this end, a number of devices have been developed to support the liquid-facilitated ingestion of pills, including those described in U.S. Pat. No. 7,055,709 to Esau, U.S. Pat. No. 6,386,358 to North et al., U.S. Pat. No. 6,047,817 to Taylor et al. and U.S. Pat. Application Publication No. 2011/0224604. However, each of these devices has certain disadvantages.

### SUMMARY

In some embodiments, a liquid-assisted pill administration device comprises a reservoir for containing a liquid and a pill receptacle for containing one or more pills. The pill receptacle has a receptacle opening remote from the reservoir for inserting and discharging pills, and the reservoir is in valve-governed fluid communication with the pill receptacle via a first fluid communication path wherein a valve is interposed in the first fluid communication path between the reservoir and the pill receptacle. The valve is selectively configurable in an open configuration in which fluid flow from the reservoir to the pill receptacle via the first fluid communication path is permitted and a closed configuration in which fluid flow from the reservoir to the pill receptacle via the first fluid communication path is obstructed. The pill administration device has a second fluid communication path into the reservoir for introducing air into the reservoir. When the reservoir contains liquid and is above the pill receptacle and the valve is in the open configuration, liquid in the reservoir flows under gravity from the reservoir to the pill receptacle via the first fluid communication path and air flows into the reservoir via the second fluid communication path.

In other embodiments, a liquid-assisted pill administration device, comprises a collapsible reservoir for containing a liquid and a pill receptacle for containing one or more pills, with the pill receptacle having a receptacle opening remote from the reservoir for inserting and discharging pills. The reservoir is in valve-governed fluid communication with the pill receptacle via a first fluid communication path wherein a valve is interposed in the first fluid communication path between the reservoir and the pill receptacle. The valve is selectively configurable in an open configuration in which fluid flow from the reservoir to the pill receptacle via the first fluid communication path is permitted, and a closed configuration in which fluid flow from the reservoir to the pill receptacle via the first fluid communication path is obstructed. When the valve is in an open configuration, collapsing the reservoir forces liquid contained therein through the valve into the pill receptacle.

The above-described liquid-assisted pill administration devices may further comprise a removable lid for selectively closing the receptacle opening. In certain implementations, the valve comprises a valve closure member movable between an open position which defines the open configuration of the valve and a closed position which defines the closed configuration of the valve, and the pill administration device further comprises a handle disposed externally of the reservoir and the pill receptacle, with the handle being coupled to the valve closure member to drive movement of the valve closure member between the open position and the closed position. The valve closure member may be coupled to the lid by the handle so that when the valve closure member is in the closed position, the lid covers the receptacle opening to close the receptacle opening and when the valve closure member is in the open position, the lid exposes the receptacle opening. The valve closure member may be rotatably received in the first fluid communication path so as to be rotatable between the open position and the closed position, and preferably rotation of the handle drives rotation of the valve closure member between the open position and the closed position. Still more preferably, rotation of the handle also pivots the lid into and out of engagement with the receptacle opening to close and open the pill receptacle, respectively.

### BRIEF DESCRIPTION OF THE DRAWINGS

These and other features of the invention will become more apparent from the following description in which reference is made to the appended drawings wherein:

FIG. 1 is a top front perspective view of an exemplary liquid-assisted pill administration device;

FIG. 2 is a top rear perspective view of the pill administration device of FIG. 1;

FIG. 3 is a first side elevation view of the pill administration device of FIG. 1;

FIG. 4 is a rear elevation view of the pill administration device of FIG. 1;

FIG. 5 is a second side elevation view of the pill administration device of FIG. 1;

FIG. 6 is a front elevation view of the pill administration device of FIG. 1;

FIG. 7 is a top plan view of the pill administration device of FIG. 1;

FIG. 8 is a bottom plan view of the pill administration device of FIG. 1;

FIG. 9 is an exploded side view of the pill administration device of FIG. 1;

FIG. 10A is a rear view of the pill administration device of FIG. 1 showing the actuator thereof in a first position;

FIG. 10B is a rear view of the pill administration device of FIG. 1 showing the actuator thereof in a second position;

FIG. 11A is a front cross-sectional view of the pill administration device of FIG. 1 showing the actuator thereof in the first position;

FIG. 11B is a front cross-sectional view of the pill administration device of FIG. 1 showing the actuator thereof in the second position;

FIG. 11C is a front cross-sectional view of the pill administration device of FIG. 1 showing the device positioned for use and the actuator thereof in a second position, with liquid flowing through the valve of the device;

FIG. 12 shows use of the pill administration device of FIG. 1;

FIG. 13 is a perspective view of the actuator of the pill administration device of FIG. 1;

FIG. 14 is a side elevation view of the pill administration device of FIG. 1 showing internal features thereof in dashed lines; and

FIG. 15 is a front cross-sectional view of a second exemplary pill administration device showing the device positioned for use and the actuator thereof in a second position, with liquid flowing through the valve of the device.

### DETAILED DESCRIPTION

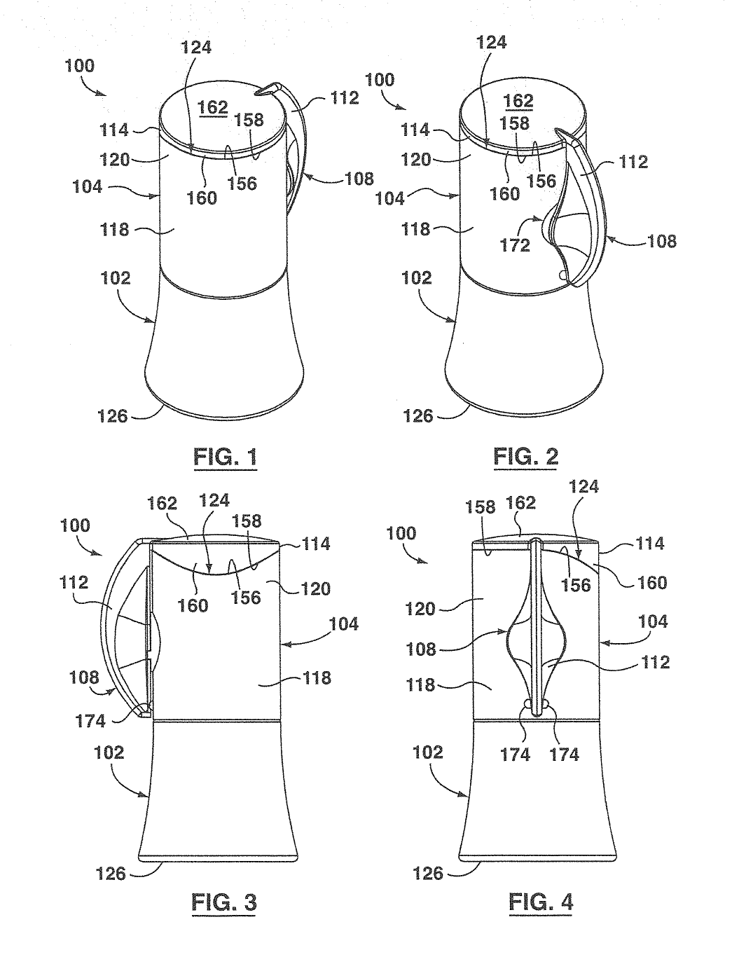

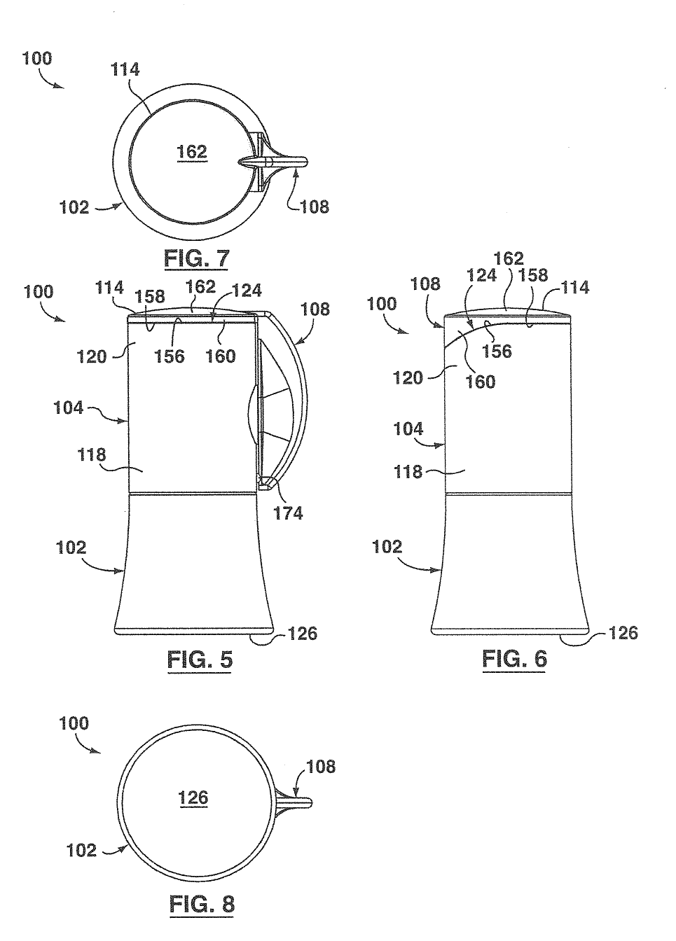

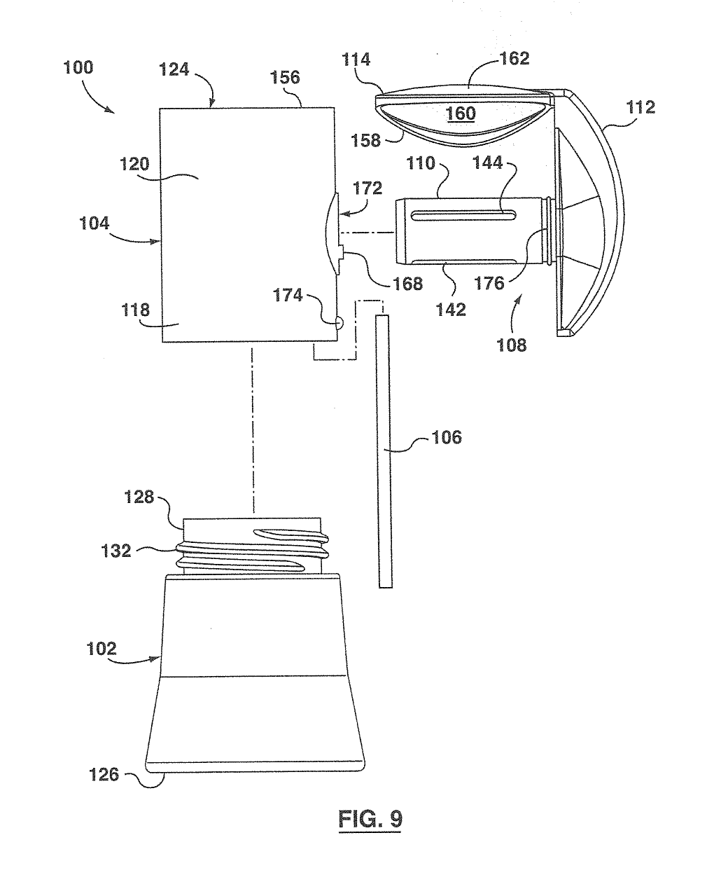

FIGS. 1 to 7 show various external views of a first exemplary liquid-assisted pill administration device, which is denoted generally by reference numeral 100. As best seen in the exploded view shown in FIG. 9, the exemplary pill administration device 100 comprises a reservoir 102 for containing a liquid, a main body 104, an air tube 106 and an actuator 108.

The actuator 108 comprises a valve closure member 110, a handle 112 and a lid 114 and is shown in greater detail in FIG. 13.

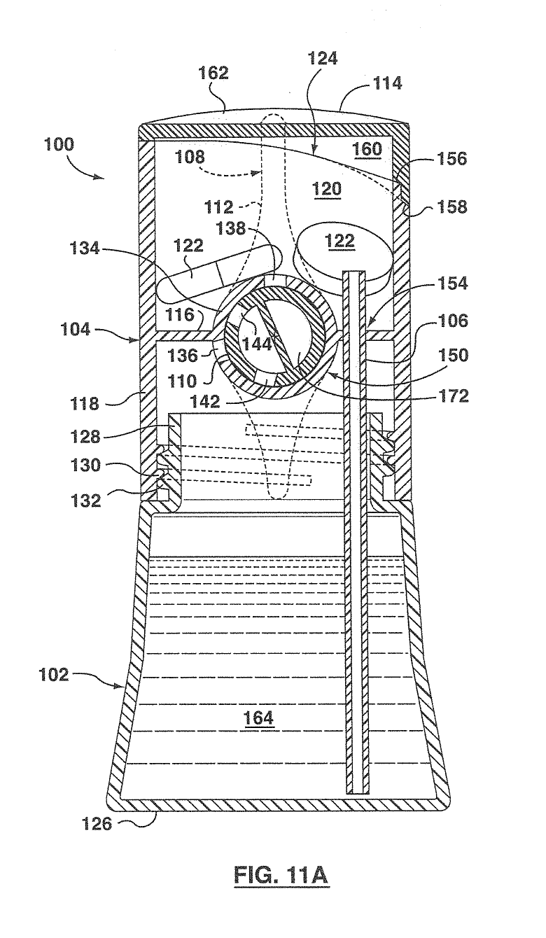

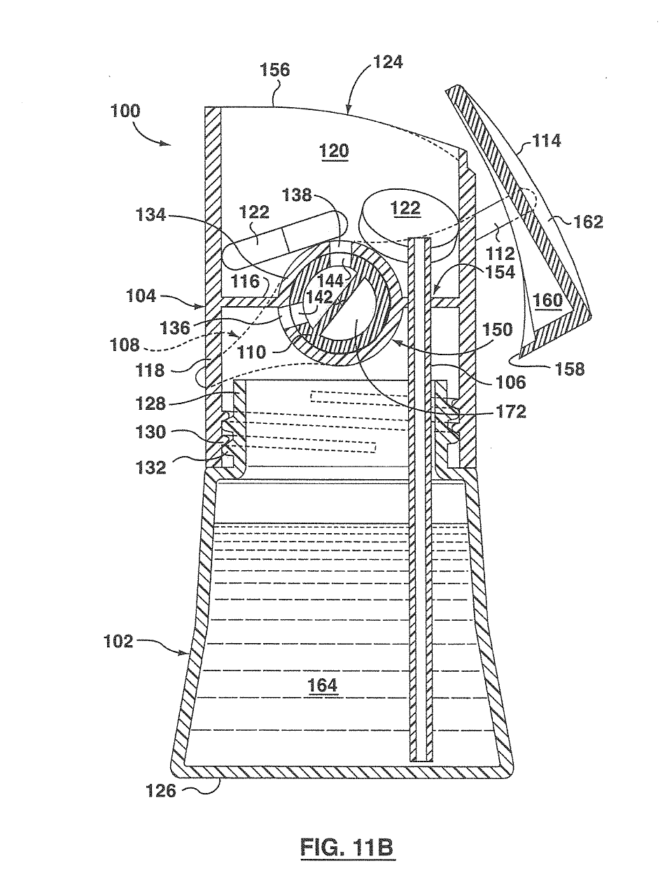

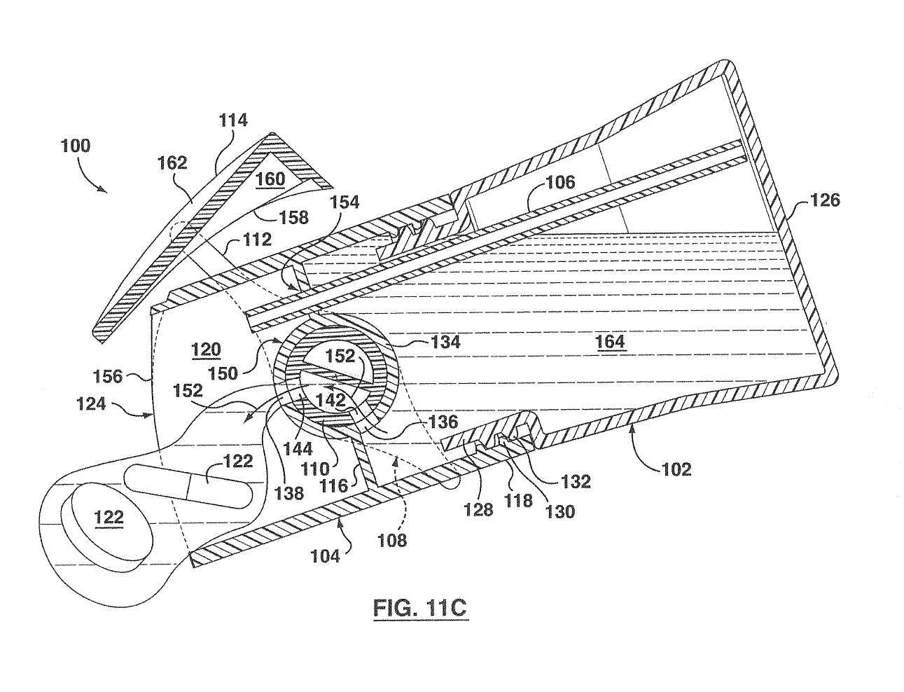

Retelling now to FIGS. 11A and 11B, the main body is divided by a divider 116 into a reservoir coupling collar 118 and a pill receptacle 120 for containing one or more pills 122. The pill receptacle 120 has a receptacle opening 124 remote from the reservoir for inserting and discharging pills, and, as explained in greater detail below, the lid 114 can be removably positioned over the receptacle opening 124 of the pill receptacle 120 for selectively closing the receptacle opening 124.

The reservoir 102 is generally campanulate and includes a flattened base 126 suitable for resting on a planar surface and has an open neck 128 opposite the base 126. The reservoir coupling collar 118 has internal threads 130 and the neck 128 of the reservoir 102 has complementary external threads 132 so that the neck 128 can be removably threadedly received in the reservoir coupling collar 118. This allows the reservoir to be filled, and refilled, with liquid 164 selected by a user. The liquid 164 may be water or a flavoured liquid, and in some embodiments, the liquid 164 may be, or may contain, medication or nutritional supplements. The reservoir 102 may be either resilient or rigid as long as the neck 128 is sufficiently rigid to be removably threadedly received in the reservoir coupling collar 118. Other structures for removably securing the reservoir to the main body, for example a snap fit, may also be used.

The divider 116 forms a hollow generally cylindrical valve body 134 which includes an upstream port 136 opening into the reservoir coupling collar 118 and a downstream port 138 opening into the pill receptacle 120.

The valve closure member 110 of the actuator 108 is hollow and generally cylindrical, and includes an upstream aperture 142 and a downstream aperture 144. The valve closure member 110 of the actuator 108 is sealingly rotatably received in the valve body 134 so as to be movable by way of rotation between a closed position (FIG. 11A) and an open position (FIG. 11B), thereby forming a complete valve 150. As can be seen, the valve 150 is interposed in a first fluid communication path between the reservoir 102 and the pill receptacle 120 so that the reservoir 102 is in valve-governed fluid communication with the pill receptacle 120 via the first fluid communication path, with the valve 150 being selectively configurable in a closed configuration (FIG. 11A) and an open configuration (FIG. 11B). The first fluid communication path is denoted by the arrow 152 in FIG. 11C.

When the valve closure member 110 is in the closed position, the apertures 142, 144 in the valve closure member 110 are out of registration with the ports 136, 138 in the valve body 134, thereby inhibiting fluid flow through the valve 150. As such, the closed position of the valve closure member 110 defines the closed configuration of the valve 150, in which fluid flow from the reservoir 102 to the pill receptacle 120 via the first fluid communication path 152 is obstructed. Conversely, when the valve closure member 110 is in the open position, the upstream aperture 142 and the downstream aperture 144 are in registration with the upstream port 136 and the downstream port 138, respectively, in the valve body 134, permitting fluid to flow through the valve 150. Accordingly, the open position of the valve closure member 110 defines the open configuration of the valve 150, in which fluid flow from the reservoir 102 to the pill receptacle 120 via the first fluid communication path 152 is permitted.

The divider also includes an air port 154 disposed exteriorly of the valve body 134. The air tube 106 is fitted into the air port 154 and extends through the reservoir coupling collar 118 into the reservoir 102 to a position adjacent the base 126 of the reservoir 102. The air tube 106 provides a second fluid communication path into the reservoir 102 for introducing air into the reservoir 102.

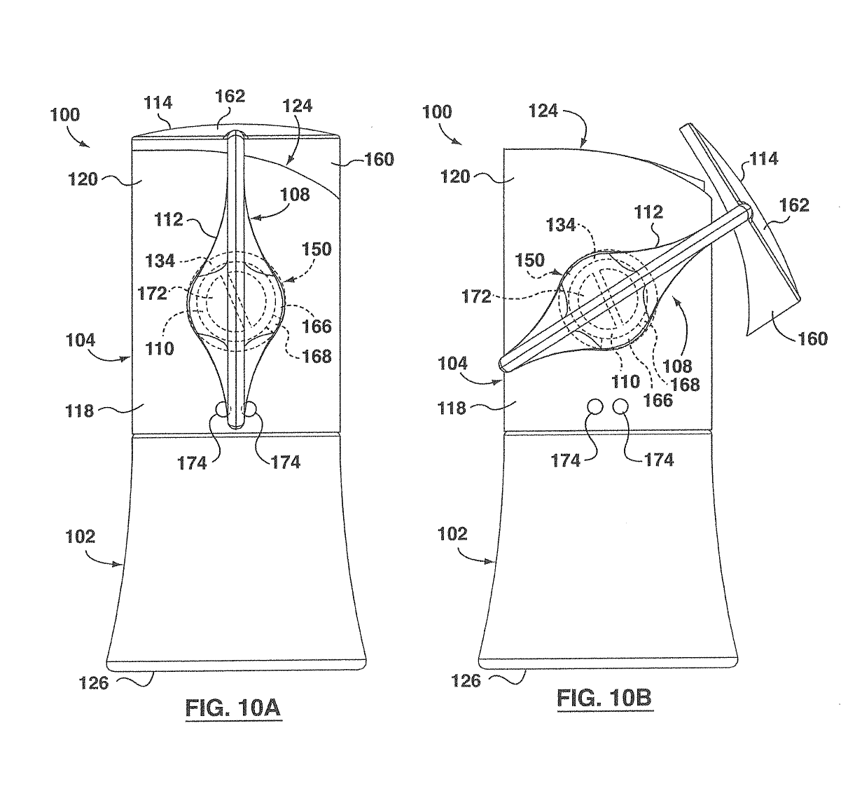

As can be seen in the Figures, the handle 112 is disposed externally of the reservoir 102 and the pill receptacle 120. As noted above, the valve closure member 110, the handle 112 and the lid 114 all form part of an actuator 108. As such, both the valve closure member 110 and the lid 114 are immovably attached to and extend from the handle 112. Because the handle 112 is immovably attached to the valve closure member 110, rotating the handle between the position shown in FIG. 11A and the position shown in FIG. 11B drives the valve closure member 110 to rotate between the open position (FIG. 11B) and the closed position (FIG. 11A) as the handle 112 pivots about the axis of rotation of the valve closure member 110. In addition, because both the valve closure member 110 and the lid 114 are immovably attached to and extend from the handle 112, the valve closure member 110 is coupled to the lid 114 by the handle 112 so that rotation of the handle 112 not only rotates the valve closure member 110 but also pivots the lid 114 into and out of engagement with the receptacle opening 124 to close and open the pill receptacle 120, respectively. As such, when the valve closure member 110 is in the closed position (FIGS. 10A and 11A), the lid 114 is in registration with and covers the receptacle opening 124 to close the receptacle opening 124, and when the valve closure member 110 is in the open position (FIGS. 10B and 11B), the lid 114 is out of registration with and exposes the receptacle opening 124.

As can best be seen in FIG. 13, the handle 112 has an arcuate recess 166 positioned adjacent the valve closure member 110, and as seen in FIGS. 9, 10A and 10B, the main body 104 has a correspondingly positioned tab 168 disposed adjacent the aperture 172 in the main body 104 through which the valve closure member 110 is inserted into the valve body 134. When the first pill administration device 100 is assembled, the tab 168 cooperates with the recess 166 to limit travel of the handle 112 in both directions and thereby prevent the valve closure member 110 from moving beyond the closed position and beyond the open position when the handle 112 is turned. In addition, the main body 104 includes two dome-shaped projections 174 positioned below the aperture 172. The dome-shaped projections 174 project outwardly far enough to engage the handle 112 and retain the actuator 108 in an orientation in which the valve closure member 110 is in the closed position unless the handle 112 is rotated with sufficient force to push the handle 112 over and past the dome-shaped projection 174.

The upper edge 156 of the pill receptacle 120 (which defines the receptacle opening 124) and the lower edge 158 of the lid 114 have complementary sloping shapes. The height of the main body 104, measured from the reservoir 102, decreases in the direction in which the superior end of the handle 112 pivots to rotate the valve closure member 110 from the closed position to the open position, and the length of the peripheral wall 160 of the lid 114, measured from the main cover portion 162 thereof, increases in the direction in which the superior end of the handle 112 pivots to rotate the valve closure member 110 from the closed position to the open position.

To prepare the first pill administration device 100 for use, a user would unscrew the reservoir 102 from the main body 104, fill the reservoir 102 with a desired liquid 164, and thread the reservoir 102 and main body 104 back together. The user would also rotate the handle 112 to pivot the lid 114 away from the receptacle opening 124, place desired pills 122 in the pill receptacle 120, and then rotate the handle 112 in the other direction to pivot the lid 114 into registration with the receptacle opening 124 to close the pill receptacle 120. These steps may be performed in any suitable order. A user can select which pills to use with the pill administration device 100. For example, a user who has a heart condition may place pills containing a medically prescribed dosage of acetylsalicylic acid (also known under the name Aspirin) into the pill receptacle 120 so that the dosage can be quickly consumed in the event of chest pain. A user may place any desired pills in the pill receptacle 120. When the pill administration device 100 is upright (e.g. resting on the base 126 of the reservoir 102) with the lid 114 closed and the valve closure member 110 in the closed configuration, the pills 122 are isolated from the liquid 164 by the divider 116 and valve 150.

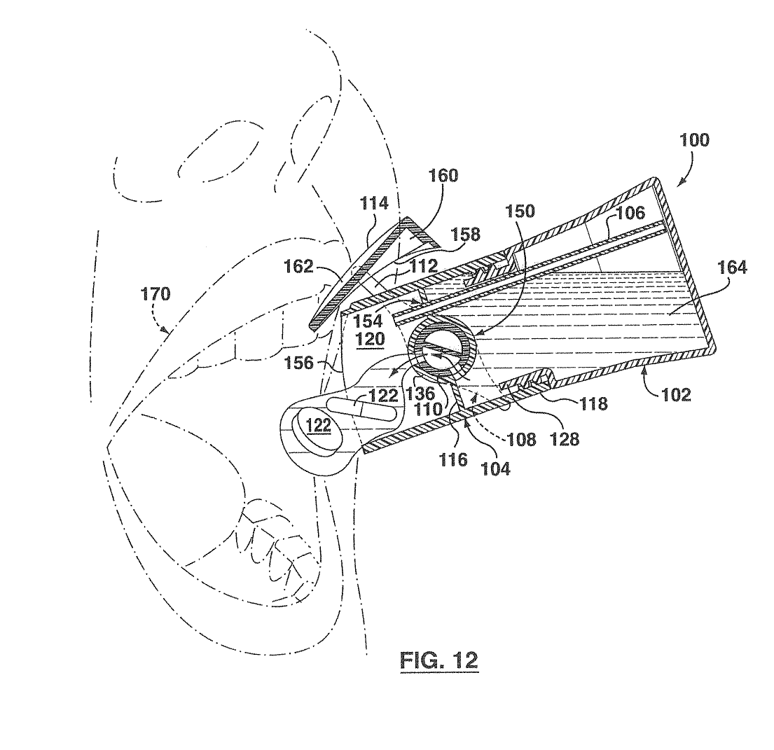

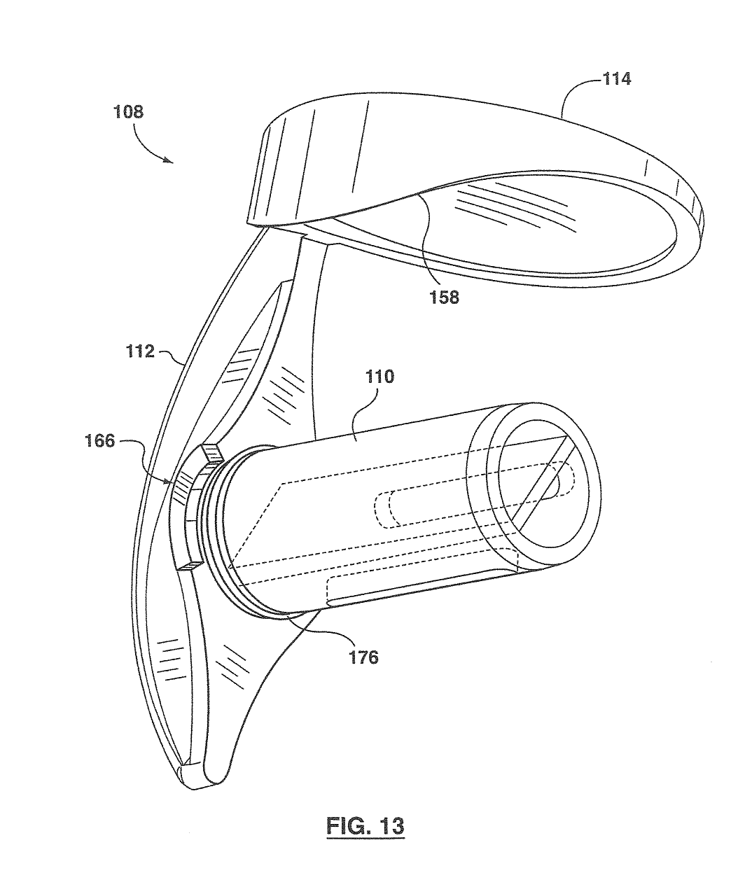

Reference is now made to FIGS. 12 and 13, which show the first exemplary liquid-assisted pill administration device 100 in use. To use the pill administration device 100, a user would turn the handle 112 to rotate the valve closure member 110 into the open position and pivot the lid 114 away from the receptacle opening 124, and then raise the pill administration device 100 to position the receptacle opening 124 in registration with the user's mouth 170. As can be seen, in this position the reservoir 102, which contains liquid 164, is positioned above the pill receptacle 120. Since the valve 150 is in the open configuration, the liquid 164 in the reservoir 102 flows under gravity from the reservoir 102 to the pill receptacle 120 via the first fluid communication path 152, and air flows into the reservoir 120 via the second fluid communication path, in this case the air tube 106. The liquid 164 entrains the pills 122 and travels through the receptacle opening 124 toward a user's mouth 170.

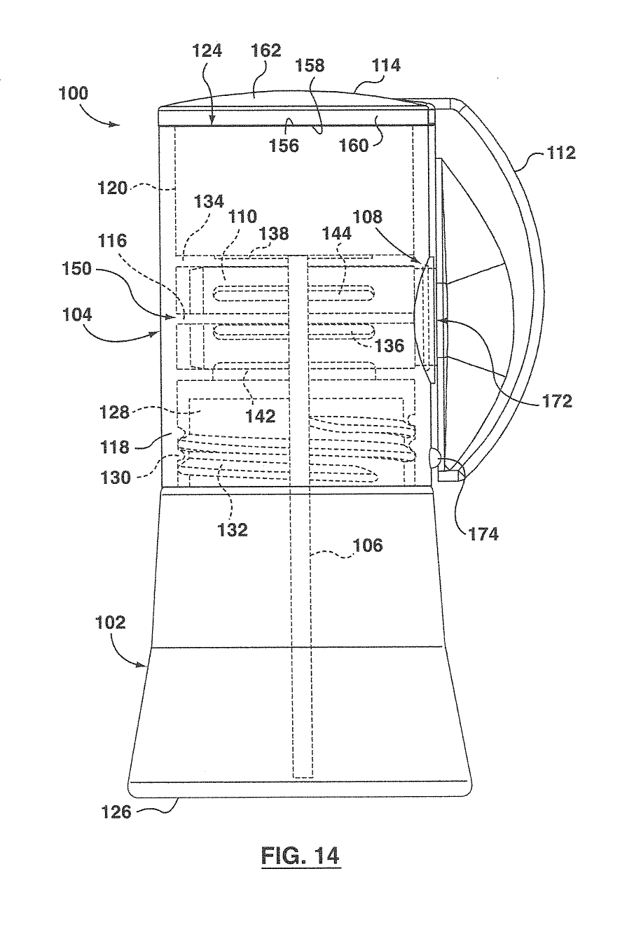

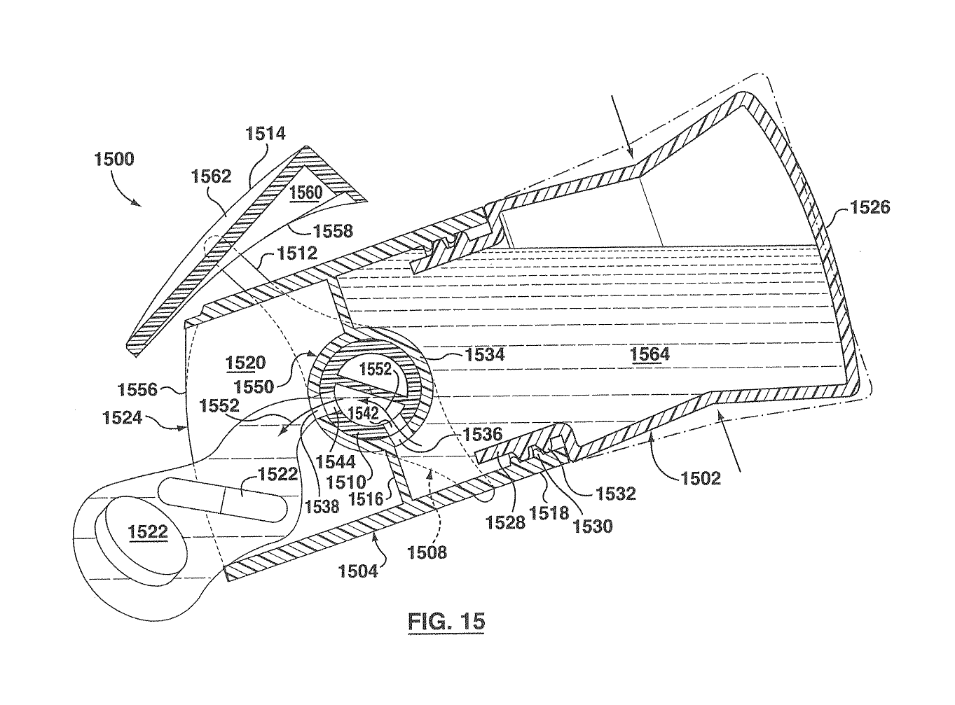

FIG. 15 shows use of a second exemplary embodiment of a liquid-assisted pill administration device, indicated generally by the reference numeral 1500. The second pill administration device 1500 shown in FIG. 15 is similar to the first pill administration device shown in FIGS. 1 to 12 and 14, with corresponding reference numerals denoting corresponding features but with the prefix “15” instead of “1”. The second pill administration device 1500 differs from the first pill administration device 100 in that the second pill administration device does not include an air tube or air port and features a collapsible reservoir 1520. In the illustrated embodiment, the reservoir 1520 is formed from a resilient material, such as a suitably pliable plastic, so that the reservoir 1520 may be collapsed by squeezing it; other embodiments may employ mechanical constructs for collapsing the reservoir, for example a plunger arrangement. Where the reservoir 1520 is formed from a resilient material, the neck 1528 should be made sufficiently thick so that it can be removably threadedly received in the reservoir coupling collar 1518.

The second pill administration device 1500 is prepared for use in the same manner as the first pill administration device 100. Use of the second pill administration device 1500 is similar to use of the first pill administration device 100, and a user would turn the handle 1512 to rotate the valve closure member 1510 into the open position and pivot the lid 1514 away from the receptacle opening 1524. The user would then raise the pill administration device 1500 to position the receptacle opening 1524 in registration with the user's mouth 1570 and collapse the reservoir 1520, in this case by squeezing it. Collapsing the reservoir 1520 drives the liquid 1564 contained therein through the valve 1550 and into the pill receptacle 1520, where the liquid 1564 entrains the pills 1520. The liquid 1564, now carrying the pills 1522, can then continue through the receptacle opening 1524 into the user's mouth 1570.

The valves 150, 1550 are merely exemplary, and other suitable valves may also be used. Similarly, while in the exemplary embodiments the valve closure members 110, 1510 are coupled to the respective lids 114, 1514 by way of direct connection to the handle 112, 1512, other embodiments may employ indirect mechanical coupling (e.g. by way of gears, etc.) of the valve closure members 110, 1510 to the respective lids 114, 1514 via the respective handles 112, 1512.

O-rings, resilient washers or other seals may be used to achieve sufficiently fluid-tight connection between parts. For example, an o-ring 176 is disposed on the valve closure member 110 adjacent the handle 112 to seal with the inside wall of the valve body 134.

Various currently preferred embodiments have been described by way of example. It will be apparent to persons skilled in the art that a number of variations and modifications can be made without departing from the scope of the claims.

What is claimed is:

1. A liquid-assisted pill administration device, comprising:
a reservoir for containing a liquid;
a pill receptacle for containing one or more pills;
the pill receptacle having a receptacle opening remote from the reservoir for inserting and discharging pills;
the reservoir being in valve-governed fluid communication with the pill receptacle via a first fluid communication path wherein a valve is interposed in the first fluid communication path between the reservoir and the pill receptacle;
the valve being selectively configurable in:
an open configuration in which fluid flow from the reservoir to the pill receptacle via the first fluid communication path is permitted; and
a closed configuration in which fluid flow from the reservoir to the pill receptacle via the first fluid communication path is obstructed;
a second fluid communication path into the reservoir for introducing air into the reservoir;
wherein, when the reservoir contains liquid and is above the pill receptacle and the valve is in the open configuration:
liquid in the reservoir flows under gravity from the reservoir to the pill receptacle via the first fluid communication path; and
air flows into the reservoir via the second fluid communication path.

2. The liquid-assisted pill administration device of claim 1, further comprising a removable lid for selectively closing the receptacle opening.

3. The liquid-assisted pill administration device of claim 2, wherein:
the valve comprises a valve closure member movable between an open position which defines the open configuration of the valve and a closed position which defines the closed configuration of the valve;
further comprising a handle disposed externally of the reservoir and the pill receptacle, the handle being coupled to the valve closure member to drive movement of the valve closure member between the open position and the closed position.

4. The liquid-assisted pill administration device of claim 3, wherein the valve closure member is coupled to the lid by the handle so that:
when the valve closure member is in the closed position, the lid covers the receptacle opening to close the receptacle opening; and
when the valve closure member is in the open position, the lid exposes the receptacle opening.

5. The liquid-assisted pill administration device of claim 4, wherein:
the valve closure member is rotatably received in the first fluid communication path so as to be rotatable between the open position and the closed position.

6. The liquid-assisted pill administration device of claim 5, wherein rotation of the handle drives rotation of the valve closure member between the open position and the closed position.

7. The liquid-assisted pill administration device of claim 6, wherein rotation of the handle pivots the lid into and out of engagement with the receptacle opening to close and open the pill receptacle, respectively.

8. A liquid-assisted pill administration device, comprising:
a collapsible reservoir for containing a liquid;
a pill receptacle for containing one or more pills;
the pill receptacle having a receptacle opening remote from the reservoir for inserting and discharging pills;
the reservoir being in valve-governed fluid communication with the pill receptacle via a first fluid communication path wherein a valve is interposed in the first fluid communication path between the reservoir and the pill receptacle;
the valve being selectively configurable in:
an open configuration in which fluid flow from the reservoir to the pill receptacle via the first fluid communication path is permitted; and
a closed configuration in which fluid flow from the reservoir to the pill receptacle via the first fluid communication path is obstructed;
wherein, when the valve is in an open configuration, collapsing the reservoir forces liquid contained therein through the valve into the pill receptacle.

9. The liquid-assisted pill administration device of claim 8, further comprising a removable lid for selectively closing the receptacle opening.

10. The liquid-assisted pill administration device of claim 9, wherein:
the valve comprises a valve closure member movable between an open position which defines the open configuration of the valve and a closed position which defines the closed configuration of the valve;
further comprising a handle disposed externally of the reservoir and the pill receptacle, the handle being coupled to the valve closure member to drive movement of the valve closure member between the open position and the closed position.

11. The liquid-assisted pill administration device of claim 10, wherein the valve closure member is coupled to the lid by the handle so that:
when the valve closure member is in the closed position, the lid covers the receptacle opening to close the receptacle opening; and
when the valve closure member is in the open position, the lid exposes the receptacle opening.

12. The liquid-assisted pill administration device of claim 11, wherein:
the valve closure member is rotatably received in the first fluid communication path so as to be rotatable between the open position and the closed position.

13. The liquid-assisted pill administration device of claim 12, wherein rotation of the handle drives rotation of the valve closure member between the open position and the closed position.

14. The liquid-assisted pill administration device of claim 13, wherein rotation of the handle pivots the lid into and out of engagement with the receptacle opening to close and open the pill receptacle, respectively.
